(19) United States
(12) Patent Application Publication
(10) Pub. No.: US 2022/0373742 A1
(43) Pub. Date: Nov. 24, 2022

(54) PASSIVELY ALIGNED OPTICAL INTERCONNECT COMPONENTS FOR PHOTONIC INTEGRATED CIRCUIT CHIPS

(71) Applicant: Intel Corporation, Santa Clara, CA (US)

(72) Inventors: Dowon Kim, Santa Clara, CA (US); Suohai Mei, Sunnyvale, CA (US)

(73) Assignee: Intel Corporation, Santa Clara, CA (US)

(21) Appl. No.: 17/327,457

(22) Filed: May 21, 2021

(51) Int. Cl. G02B 6/30; G02B 6/12; G02B 6/42

(52) U.S. Cl. CPC G02B 6/30; G02B 6/12; G02B 6/4292

(57) ABSTRACT

Monolithic optical interconnect component components for surface mounting to photonic IC (PIC) chip assemblies. A protrusion or detent in solid body of the component comprises a contact alignment surface that stands off from a remainder of the solid body and is sloped to facilitate passive alignment of the component to a surface feature of the PIC chip. A face of the solid body may include an interference fitting to receive an MT ferrule connector. An optical interconnect component may include an array of optical elements and/or optical waveguides embedded within a solid body and extending between faces of the solid body. Once assembled, a multi-fiber push-on (MPO) connector may be inserted into the surface mounted interconnect component to optically couple a fiber cable to the PIC chip.

### BACKGROUND

In electronics manufacturing, integrated circuit (IC) packaging is a stage of manufacture where an IC that has been fabricated on a die or chip comprising a semiconducting material is coupled to a supporting case or “package” that can protect the IC from physical damage and support electrical interconnect suitable for further connecting to a host component, such as a printed circuit board (PCB). In the IC industry, the process of fabricating a package is often referred to as packaging, or assembly.

A photonic integrated circuit (PIC) includes integrated photonic devices or elements. PICs are preferred to optical systems built with discrete optical components and/or optical fiber because of the more compact size, lower cost, heightened functionality, and performance of PICs. Silicon PICs (SiPh) have one or more planar silicon photonic waveguides having diameters less than 1 μm, which convey light within the PIC. These planar silicon waveguides terminate at an optical output coupler (OC) suitable for coupling to an optical fiber array (FA) comprising fibers having diameters on the order of a hundred microns.

Optical coupling efficiency between the PIC waveguide OC and the FA is an important optical device performance metric that depends on positional alignment of the FA to features on the PIC. In assembly, passive FA alignment techniques typically place individual fibers within V-grooves formed in the PIC. However, such passive alignment methods typically have lower yield and higher coupling loss than active alignment techniques. Active FA alignment requires an expensive optical aligner, for example having a 3σ positioning capability of <μm. The expensive tooling weakens cost competitiveness of the PIC based device of optical modules. Also, a longer cycle time associated with active alignment decreases the unit/hour assembly of the packaged optical devices, limiting economy of scale.

### BRIEF DESCRIPTION OF THE DRAWINGS

The subject matter described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an exploded isometric illustration of a system including a photonic IC (PIC) chip assembly including a passively aligned optical interconnect component, in accordance with some embodiments;

FIGS. 2A, 2B, and 2C illustrate isometric views of PIC chip land surfaces comprising protrusions or detents suitable for interfacing with a passively aligned optical interconnect component, in accordance with some embodiments;

FIG. 3 is a transverse cross-sectional view of sloped contact alignment surfaces of a complementary detent and protrusion, in accordance with some embodiments;

FIGS. 4A, 4B, and 4C are longitudinal cross-sectional views of an edge-coupled PIC chip package including a passively aligned optical interconnect component, in accordance with some embodiments;

FIG. 5 is a graph illustrating reduced optical coupling loss for an optical interconnect component comprising a collimation lens, in accordance with some embodiments;

FIGS. 6A, 6B, and 6C are longitudinal cross-sectional views of a vertically-coupled PIC chip assembly including a passively aligned optical interconnect component, in accordance with some embodiments;

FIG. 7 is an exploded isometric illustration of a system including a photonic IC (PIC) chip assembly including a passively aligned optical interconnect component, in accordance with some embodiments;

FIG. 8A is an isometric illustration of an optical interconnect component comprising a lens array and mirror facets, in accordance with some alternative embodiments;

FIG. 8B is a transverse cross-sectional view of the optical interconnect component depicted in FIG. 8A, in accordance with some embodiments;

FIG. 8C is a longitudinal cross-sectional view of an edge-coupled PIC chip assembly including the optical interconnect component illustrated in FIG. 8A-8B, in accordance with some embodiments;

FIG. 9A is a transverse cross-sectional view of an optical interconnect component, in accordance with some alternative embodiments;

FIG. 9B is a longitudinal cross-sectional view of an edge-coupled PIC chip package including the optical interconnect component illustrated in FIG. 9A, in accordance with some embodiments;

FIGS. 9C and 9D are longitudinal cross-sectional views of a vertically-coupled PIC chip assembly including an optical interconnect component, in accordance with some alternative embodiments;

FIG. 10 is an isometric illustration of an optical interconnect component comprising a lens array and interference fittings, in accordance with some alternative embodiments

FIG. 11 is an isometric illustration of a system including PIC chip assembly including two passively aligned optical interconnect components, in accordance with some embodiments;

FIG. 12 illustrates a mobile computing platform and a data server machine employing PIC chip assembly including one or more passively aligned optical interconnect components, in accordance with some embodiments; and

FIG. 13 is a functional block diagram of an electronic computing device, in accordance with some embodiments.

### DETAILED DESCRIPTION

Embodiments are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. It should be understood that these terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause and effect relationship).

The terms “over,” “under,” “between,” and “on” as used herein refer to a relative position of one component or material with respect to other components or materials where such physical relationships are noteworthy. For example in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct physical contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

Unless otherwise specified in the explicit context of use, the term “predominantly” means more than 50%, or more than half. For example, a composition that is predominantly a first constituent means more than half of the composition is the first constituent (e.g., <50 at. %). The term “primarily” means the most, or greatest, part. For example, a composition that is primarily a first constituent means the composition has more of the first constituent than any other constituent. The term “substantially” means there is no more than incidental variation from a target value. For example, a composition that is substantially a first constituent means the composition only includes trace levels of any constituent other than the first constituent.

Monolithic optical interconnect component components that are passively aligned during their assembly upon a photonic IC (PIC) chip are described herein. A protrusion or detent in the interconnect component solid body has one or more contact alignment surfaces that stand off from a remainder of the solid body, and are sloped to facilitate passive alignment to a surface feature of the PIC chip. The optical interconnect component solid body may further comprise an interference fitting, such as one or more dimensioned holes to receive pins of an MT ferrule connector. The optical interconnect component may include an array of optical elements and/or optical waveguides embedded within the solid body. Once assembled to the PIC chip, a multi-fiber push-on (MPO) connector may be inserted into the operation interconnect component to couple a fiber cable to the PIC chip.

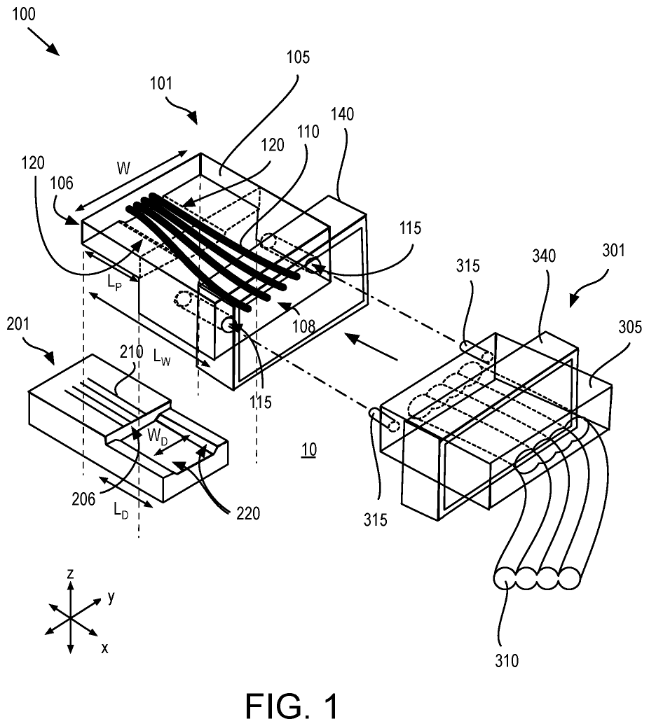

FIG. 1 is an exploded isometric illustration of a system including a PIC chip assembly 100 including an optical interconnect component 101 passively aligned to a PIC chip 201, in accordance with some embodiments. Passive alignment occurs during a surface mount assembly operation performed, for example, by a pick-and-place machine having only moderate alignment accuracy of 3-5 μm (3σ). As further described below, optical interconnect component 101 and PIC chip 201 have sloped contact alignment surfaces that are to induce lateral movement (along x and/or y axis) through their physical contact when a vertical force (along z-axis) is applied between interconnect 101 and PIC chip 201. Dimensions of the sloped alignment surfaces are sufficient to ensure their engagement during the surface mount assembly operation.

Once assembled, PIC chip assembly 100 may be further assembled onto a host substrate 10. Host substrate 10 may be a package substrate/interposer, or host substrate 10 may be a printed circuit board, for example. A “press-fit” or “push-on” optical fiber connector 301, such as an MT-ferrule, may plug into optical interconnect component 101. Optical interconnect component 101 may therefore be referred to as a passively aligned MT-pluggable optical interconnect component (MT-POC).

Optical interconnect component 101 comprises a solid body 105, which in some embodiments is silica or bororsilicate glass. Solid body 105 may be of alternate materials, such as, but not limited to, polymeric materials. A plurality of 3D optical waveguides 110 are embedded within solid body 105. Waveguides 110 may be freeform/directly written within solid body 105, for example with a UV femtosecond laser. Waveguides 110 extend a longitudinal length L_{w} between a solid body face 106 and solid body face 108. In the illustrated example, faces 106 and 108 are substantially parallel, and each is within a plane defined by only the z and y axes. Longitudinal length L_{w} is along the x-axis. Waveguides 110 may have any transverse diameter (e.g., 0.3-100 μm, or more), and the transverse diameter may be constant over longitudinal length L_{w}, or may vary (e.g., for an expanding mode) over longitudinal length L_{w}. Waveguides 110 are linearly, or two-dimensionally, arrayed at each of faces 106 and 108 along a transverse width W of solid body 105. Proximal to faces 106 and 108, waveguides 110 are co-planar in the z-dimension. In the illustrated example, waveguides 110 have a smaller pitch in the y-dimension proximal to face 106, and a larger pitch in the y-dimension proximal to face 108. Alternatively, waveguide pitch within solid body 105 may be constant (i.e., having the same pitch at faces 106 and 108). Waveguide pitch may also be larger proximal to face 106 than face 108.

Solid body 105 further comprises a mount surface that is to be surface mounted to a land of PIC chip 201. The mount surface includes at least one contact alignment surface 120 that is sloped to be non-parallel and non-normal to the x-y plane. In the illustrated embodiment, the mount surface includes a pair of complementarily sloped alignment surfaces 120 that extend over a protrusion length L_{P} in a direction parallel to the x-axis. In the illustrated example, protrusion length L_{P} comprises only a portion of waveguide length L_{w}. Both sloped alignment surfaces 120 may be described by a linear function ƒ(y,z). In some examples, sloped alignment surfaces 120 are bisected by a plane parallel to the plane of the z and x axes. Sloped alignment surfaces 120 stand-off in the z-dimension from a remainder of solid body 105 so that the alignment surfaces 120 will make first contact with a surface PIC chip 201 during an assembly process.

In the illustrated example, sloped alignment surfaces 120 are two sides of a “v” or “u” shaped protrusion. However, in alternative embodiments, sloped alignment surfaces 120 may instead comprise two sides of a “v” or “u” shaped detent. As described further below, the lateral run of the sloped alignment surfaces 120 (e.g., along the y-axis) is sufficient to accommodate the alignment capability of a given pick-and-place machine. Physical contact between sloped alignment surfaces 120 and a land of PIC chip 201 will translate a component of the surface mounting force applied in the z-axis into lateral motion that ends only upon bottoming out the z-axis travel of sloped alignment surfaces 120 during a surface mount operation. Alignment surfaces 120 may be machined or molded into solid body 105. Because optical waveguides 110 may be directly written within solid body 105, the location of alignment surfaces 120 relative optical waveguides 110 may be tightly controlled, for example to <1 μm accuracy within each of the x,y,z axes.

PIC chip 201 includes a plurality of planar optical waveguides (WG) 210, and may further comprise electrically active structures with one or more electrical terminals (not depicted). Waveguides 210 are advantageously of silicon and utilize refractive index contrast between the silicon and a cladding material (e.g., silicon dioxide) to confine optical modes within the silicon structures. Such photonic structures are therefore referred to as silicon photonic (SiPh) structures. Notably, optical waveguides 210, and other SiPh structures, have sub-micron critical dimensions. For example, a transverse width of an individual one of waveguides 210 may range from 150 nm to 400 nm. Although four waveguides 210 are illustrated in FIG. 1, a PIC may have any number of planar waveguides, such as 8, 16, 32, 64, etc. Waveguides 210 are co-planar (e.g., within a plane parallel to the x-y plane) and are in a linear array along the y-axis. Waveguides 210 terminate at an optical output coupler (OC) that is to interface with optical interconnect component 101. In the example illustrated in FIG. 1, waveguides 210 terminate at an edge coupler (EC) comprising an edge facet 206. Edge facet 206 is parallel to the z-y plane.

In addition to waveguides 210, PIC chip 201 may include other SiPh structures, such as a Mach-Zhender interferometer (MZI), micro-ring resonator (MRR), or micro-ring oscillator (MRO), an electro-optical absorber (EOA), a PiN photodiode/photodetector (PD), or laser emitter. Although not illustrated, a hybrid laser and/or a hybrid PD may be attached to PIC chip 201 over regions of optical waveguides 210. A hybrid laser and hybrid PD is referred to as “hybrid” because they include a semiconductor other than silicon, such as, but not limited to, a III-V compound semiconductor material that is prefabricated into a chip/chiplet that is then bonded to a surface of PIC chip 201.

PIC chip 201 includes a land laterally adjacent to waveguides 210. The land is to interface with the mount surface of solid body 105. The land includes at least one contact alignment surface 220 that is sloped to be non-parallel and non-normal to the x-y plane. In the illustrated embodiment, the land includes a pair of complementarily sloped alignment surfaces 220 that extend over a detent length L_{D} in a direction parallel to the x-axis. Detent length L_{D} may be at least as long as protrusion length L_{SM}, for example. Both sloped alignment surfaces 220 may be described by a linear function ƒ(y,z). In some examples, sloped alignment surfaces 220 are bisected by a plane parallel to the plane of the z and x axes. Sloped alignment surfaces 220 stand-off in the z-dimension from a remainder of the land so that, during assembly, the alignment surfaces 220 will make first contact with alignment surfaces 120.

In the illustrated example, the sloped alignment surfaces 220 are two sides of a “v” or “u” shaped detent that has a transverse detent width W_{D} matching (i.e., equal to, or larger than) a protrusion width defined by alignment surfaces 120. In alternative embodiments wherein alignment surfaces 120 define a detent, alignment surfaces 220 may instead comprise two sides of a “v” or “u” shaped protrusion similarly dimensioned to interface with the detent. The lateral run of alignment surfaces 220 may match that of alignment surfaces 120. Physical contact between interfacing sloped alignment surfaces 120 and 220 promotes a lateral motion along the y-axis of a finite distance for an amount of z-axis travel during surface mount of interconnect 105 to PIC chip 201.

Alignment surfaces 220 may be fabricated in PIC chip 201 with a masked etch process so that the location of alignment surfaces 220 relative optical waveguides 210 may be tightly controlled, for example to <1 μm accuracy within each of the x,y,z axes. Within the y-axis, passive alignment between surfaces 120 and 220 can therefore align individual ones of waveguides 110 to corresponding ones of waveguides 210 to within 2 μm, and advantageously to less <1 μm. Since both waveguides 110 and 210 are linear arrays extending a direction parallel to the y-axis, z-axis positional accuracy is dependent upon a controlled collapse of an adhesive (not depicted) that may be located, for example, between the PIC land and mount surface of optical interconnect component 101. X-axis positional accuracy may be allowed to depend upon the accuracy of the pick-and-place machine, for example allowing a gap between edge facet 206 and solid body face 106 to be 3 μm, or more. If higher x-axis positional accuracy is desired multi-dimensional alignment surfaces may be defined, for example as described further below.

Optical interconnect component 101 further comprises interference fittings 115 that are to interface with complementary interference fittings 315 of optical fiber connector 301. In the illustrated embodiment, fiber connector 301 is a multi-fiber push-on connector (MPO) having at least as many optical fibers 310 as waveguides 110. Optical fibers 310 may be single-mode, single clad fibers, for example with a core diameter of 8-10 μm. Fibers 310 are molded into a plastic body 305. Friction between interference fittings 115 and 315 are to hold a face of body 305 in close proximity to, and substantially parallel with, solid body face 108 so that individual ones of waveguides 110 are optically coupled to corresponding ones of optical fibers 310.

In the exemplary embodiment, interference fittings 115 comprise a pair of recesses, or holes, machined or molded into solid body 105. The pair of recesses are laterally spaced apart to be on opposite sides of the linear array of waveguides 110. For such embodiments, interference fittings 315 are pins, each dimensioned to fit tightly within one recess. In alternative embodiments, interference fittings 115 may comprise a pair of pins machined or molded into solid body 105 while interference fittings 315 are complementary recesses. Each of fiber connector 301 and optical interconnect component 101 are illustrated as further including an optional bracket or receptacle 340, 140.

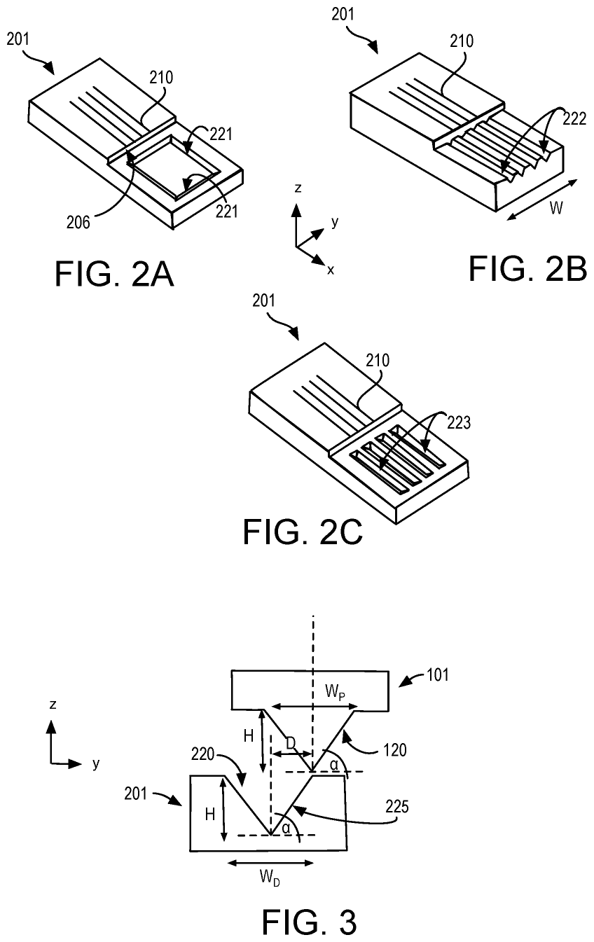

FIGS. 2A, 2B, and 2C illustrate isometric views of PIC chips 201 including surface protrusions or detents suitable for interfacing with a passively aligned optical interconnect component, in accordance with some alternative embodiments. Although not illustrated, each of the exemplary structures are to interface with a complementary detent or protrusion that is on a face of an optical interconnect component that is otherwise the same as optical interconnect component 101 (FIG. 1).

In FIG. 2A, PIC chip 201 includes a land surrounded by orthogonal sloped alignment surfaces 221. Sloped alignment surfaces 221 intersect to define a polygonal detent. One pair of parallel, opposing alignment surfaces 221 will therefore induce lateral translation along the y-axis while the orthogonal parallel pair of alignment surfaces 221 will passively induce lateral translation along the x-axis. X-axis positional accuracy for the embodiment illustrated in FIG. 2A may therefore reduce a gap between edge facet 206 and solid body face 106 (FIG. 1) to less than the alignment capability of a reference pick-and-place machine (e.g., <2 μm, and advantageously <1 μm).

In FIG. 2B, PIC chip 201 has a land comprising a plurality of parallel v-grooves 222. V-grooves 222 may offer substantially the same positional accuracy along the y-axis as the embodiment illustrated in FIG. 1. However, each one of v-grooves 220 may be advantageously dimensioned to passively align individual optical fibers. An optical interconnect component having complementary v-protrusions will therefore interface with v-grooves 220 while enabling PIC chip 201 to be backward compatible with alternative passive optical fiber assembly techniques. In FIG. 2C, PIC chip 201 has a land comprising a plurality of detents 223 to emphasize that passive alignment surfaces may be provided within any number of protrusions and/or detents.

FIG. 3 illustrates a transverse cross-section through sloped contact alignment surfaces of a complementary detent and protrusion, in accordance with some embodiments. As shown, optical interconnect component 101 includes a protrusion having an apex stand-off height H with alignment surfaces 120 sloped down from the apex at an oblique angle α along a transverse distance D. Distance D may be defined to be large enough (e.g., 50-100 um) to enable placement by an assembly machine with only moderate accuracy, reducing assembly cost and cycle time The v-protrusion is symmetrical, having a maximum protrusion width W_{P} equal to twice distance D, so that the full placement error in either direction along the y-axis can be rectified through the application of a downward (e.g., along z-axis) mounting force. Accordingly, in some examples, protrusion width Wp is at least 50 μm, and may be 100 μm, or more.

As further illustrated in FIG. 3, PIC chip 201 includes a groove having a depth of at least H. Alignment surfaces 220 slope up from the bottom at an oblique angle no steeper than α along a transverse distance of at least D. In this example, the groove is a symmetrical v-groove, having a maximum detent width W_{D} of at least equal to twice distance D. Although FIG. 3 illustrates exactly complementary alignment structures, it is noted that dimensions of the groove may be oversized by any amount.

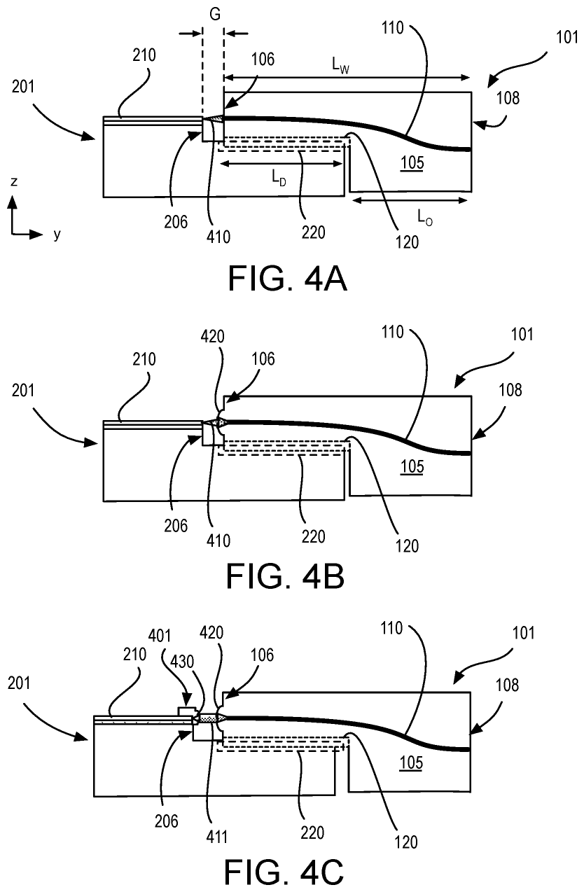

FIG. 4A-4C are longitudinal cross-sectional views of an edge-coupled PIC chip assembly including a passively aligned optical interconnect component in accordance with some embodiments. FIG. 4A further illustrates optical connector 101 attached to PIC chip 201, substantially as introduced in FIG. 1. As shown in FIG. 4A, during operation of PIC chip 201, an optical beam 410 is emitted from an edge coupler of planar waveguide 210. Optical beam 410 propagates through free space over gap G between edge facet 206 and solid body face 106. Optical beam 410 enters solid body 105 through face 106 and is propagated through solid body 105 by waveguide 110 which terminates proximal to solid body face 108. Although not illustrated, a light beam launched from waveguide 110 is to enter an optical fiber embedded within an MT-ferrule, for example. Hence, optical interconnect component 101 introduces an additional output coupler between an optical fiber and planar waveguide 110 for at least the advantages of a pluggable MT-connection and improved coupler efficiency as a result of superior passive alignment between waveguides 110 and 210.

In FIG. 4A, dotted lines represent alignment surfaces 120 while dashed lines represent alignment surfaces 220. The alignment surfaces make contact over at least some portion of detent length L_{D}, which in this example extends to an edge sidewall of PIC chip 201. An overhanging length Lₒ of solid body 105 extends beyond the edge sidewall of PIC chip 201. In this example, optical beam 410 is divergent over gap G. As such, gap G is advantageously less than a few hundreds of microns for no more than 3 dB loss.

In some embodiments, an optical element is integrated into an optical interconnect component to improve coupling with planar waveguides of a PIC chip, for example by refocusing a diverging beam entering the optical interconnect component from free-space propagation, or by changing the direction of beam propagation. In some embodiments, a solid body of the optical interconnect component comprises one or more optical elements molded or machined into a face of the solid body. Each optical element may be at least one of an optical lens or total internal reflection (TIR) mirror, for example.

In FIG. 4B, optical interconnect component 101 includes a convex lens 420 on solid body face 106. Convex lens 420 has a focal distance that intersects one of the optical waveguides 110. The refocusing possible with convex lens 420 reduces coupling losses associated with a larger gap G (x-axis) as well as transverse misalignment (y-axis) and vertical misalignment (z-axis). In exemplary embodiments where waveguide 210 is one of a plurality of waveguides in a linear array, convex lens 420 is one of a plurality of convex lenses linearly arrayed over face 106 (e.g., along the y-axis in/out of page). Each convex lens 420 of the array is to refocus a beam emitted from a single waveguide edge coupler.

In addition to integrating an optical element with the freeform waveguide of optical interconnect component 101, one or more optical elements may be separately mounted to the planar waveguide output couplers. For embodiments where a PIC chip includes a linear array of planar waveguides (e.g., 4, 8, 16, etc.), an optical interconnect component comprising a linear array of optical elements may be mounted to the PIC chip to improve coupling between the PIC waveguide output coupler and the optical interconnect component 101, and/or an optical fiber array.

FIG. 4C illustrates a PIC chip assembly that includes optical interconnect component 101 and PIC chip 201, substantially as described above, and further includes an optical interconnect component 401. In this example, optical interconnect component 401 includes a collimation lens 430 molded or machined into a solid body, which may be glass or polymer, for example. As shown, optical interconnect component 401 is surface mounted over planar waveguide(s) 210 and overhangs edge facet 206, resulting in a collimated beam 411 propagating through free-space within gap G. Alternatively, optical interconnect component 401 may be mounted only to edge facet 206. With collimation, signal loss attributable to divergence is reduced. For such embodiments, optical interconnect component 101 may include focusing lens 420 substantially as described above in the context of FIG. 4A, or solid body face 106 may be a planar/flat surface substantially described above in the context of FIG. 4A. Collimation lens 401 and refocusing lens 420 can increase the alignment tolerance of optical interconnect component 101.

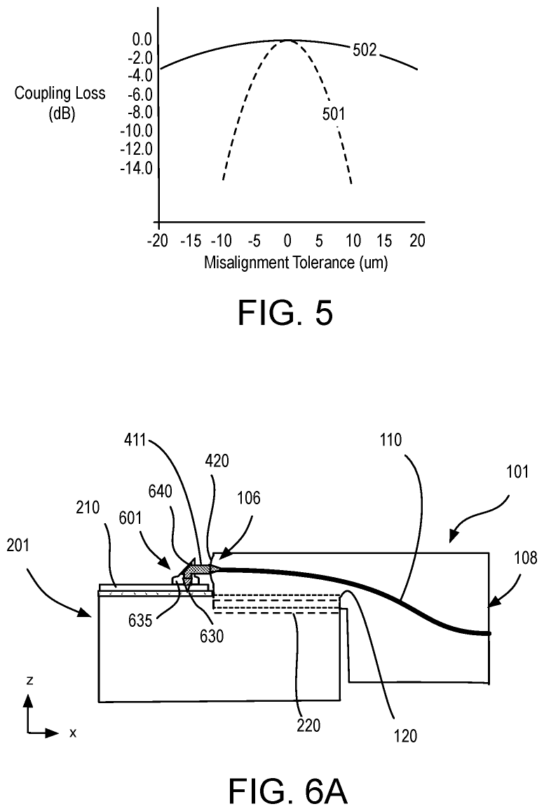

FIG. 5 is a graph illustrating reduced optical coupling loss for an assembly including optical interconnect component 401 comprising a collimation lens, in accordance with some embodiments. In FIG. 5, dashed line 501 illustrates the coupling loss in decibels as a function of misalignment of optical interconnect component 101 (or an optical fiber) relative to the edge coupler in microns along either of the x or y axes. As shown, alignment within 3 μm is needed for no more than 3 dB loss. Solid line 502 illustrates how a collimation lens mounted in contact with the edge coupler reduces the positional sensitivity of optical interconnect component 101. Hence, the challenge of passively aligning optical interconnect component 101 may be reduced by introducing optical interconnect component 401. Since optical interconnect component 401 is also surface mounted, optical interconnect component 401 is also aligned to one or more features of the PIC chip. Alignment of optical interconnect component 401 may be either passive or active. In some exemplary embodiments further described below, optical interconnect component 401 is passively aligned to waveguide(s) 210 and/or edge facet 206 through one or more sloped alignment surfaces, such as any of those described above for optical interconnect component 101.

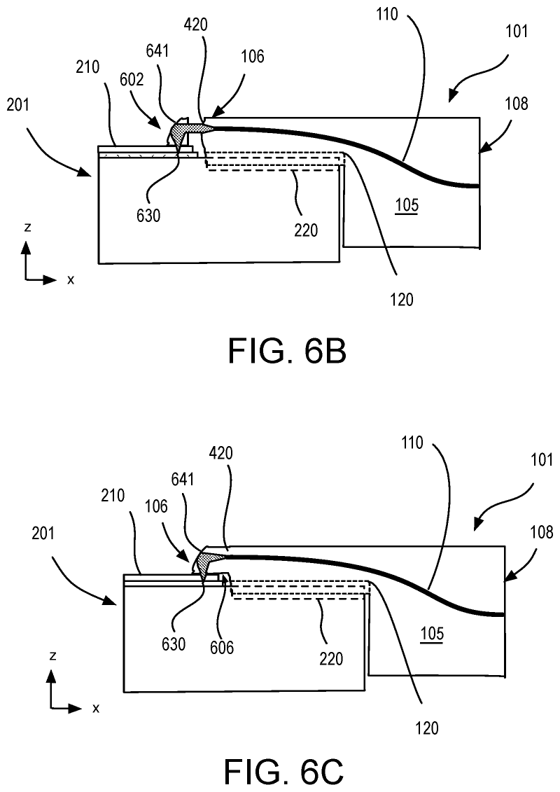

An optical interconnect component mounted over planar waveguides of a PIC chip may comprise one or more TIR mirrors, for example to redirect a vertically oriented output coupler of a PIC chip to a horizontally oriented waveguide of optical interconnect component 101 and/or of a fiber array. FIG. 6A-6C are longitudinal cross-sectional views of vertically-coupled PIC chip assemblies including one or more passively aligned optical interconnect components in accordance with some embodiments.

FIG. 6A illustrates a PIC chip assembly including optical interconnect component 101 substantially as described above in the context of FIG. 4A, with solid body face 106 comprising integrated focusing lens(es) 420 and waveguide(s) 110 within a focal distance of lens(es) 420. PIC chip 201 however comprises a waveguide 210 terminating at a vertical coupler (VC) 630. In contrast to an edge coupler, vertical coupler 630 is a vertically oriented output coupler. Vertical output coupler 630 may comprise a grating coupler (GC), for example. However, vertical optical couplers may have any other suitable architecture, such as, but not limited to a vertically redirected edge coupler.

An optical interconnect component 601 is surface mounted over vertical coupler 630 and includes an angled or sloped flat/planar TIR mirror 640. For the illustrated embodiment where vertical coupler 630 emits a divergent beam, optical interconnect component 601 further includes an integrated collimation lens 635. Optical interconnect component 601 therefore couples a horizontally collimated beam 411, which is focused by lens 420 into waveguide(s) 110 of optical interconnect component 101. Optical interconnect component 601 may comprise a solid body having any suitable composition, such as any of those described for optical solid body 105.

FIG. 6B illustrates another exemplary embodiment including optical interconnect component 101 substantially as described above. PIC chip 201 again includes planar optical waveguide(s) 210 that terminate at vertical coupler 630. In this example, optical interconnect component 602 comprises an integral parabolic TIR mirror 641, which will also couple a horizontally collimated beam propagated over a free space gap to optical interconnect component 101.

FIG. 6C illustrates an embodiment where optical interconnect component 101 includes a conic TIR mirror 641 for coupling vertically-oriented and horizontally-oriented optical beams. In this example, TIR mirror 641 is in solid body face 106 with a (flat) face 606 of solid body 105 being parallel to vertical coupler 630. The PIC chip assembly illustrated in FIG. 6C therefore combines structures of the two optical interconnect components 601 and 101 illustrated in FIG. 6B. Hence, a single optical interconnect component 101 may be machined and/or molded to directly couple with vertical coupler 630 of PIC chip 201. Such embodiments have the advantage of controlling any free-space gap between vertical coupler 630 and optical interconnect component 101 through controlled collapse along the z-axis. Alignment surfaces 120 and 220 then facilitate passive alignment of TIR mirror 641 within at least the transverse y-axis, and potentially also the longitudinal x-axis.

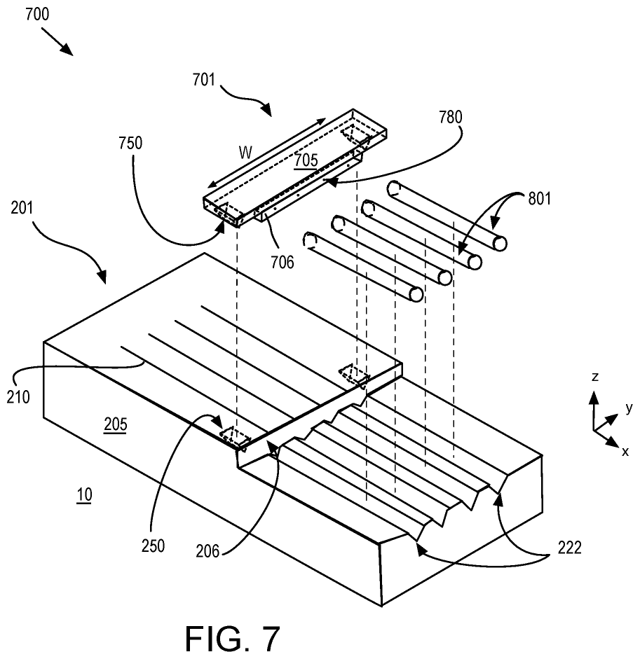

FIG. 7 is an exploded isometric illustration of a system including a PIC chip assembly 700 including a passively aligned optical interconnect component 701, in accordance with some embodiments. As described for embodiments above, optical interconnect component 701 is a solid body component that is assembled upon a land of PIC chip 201. Optical interconnect component 701 may have any of the properties of optical interconnect component 401 (FIG. 4C), 601 (FIG. 6A) or 602 (FIG. 6B) described above. As illustrated in FIG. 7, PIC assembly 700 includes a number of v-groove alignment surfaces 222 having a 1:1 correspondence with the number of waveguides 210 (e.g., 4). As noted above, alignment surfaces 222 are therefore suitable both for passively aligning optical interconnect component 101 (FIG. 1), or as illustrated in FIG. 7, an optical fiber array comprising a number of optical fibers 701. Individual ones of optical fibers 701 are seated within a corresponding v-groove.

Optical interconnect component 701 includes one or more optical elements arrayed over transverse width W. The optical elements may comprise a lens or TIR mirror integral with solid body 705. In the illustrated example, optical interconnect component 701 comprises a plurality of lenses 780 in solid body face 706. Lenses 780 have a pitch in the y-axis equal to that of planar waveguides 210. Planar waveguides 210 terminate at edge couplers on edge face 206. Individual ones of lenses 780 condition an optical beam that propagates between an individual edge coupler and an individual optical fiber 801. For example, lenses 780 may be collimation lenses that improve assembly tolerance to misalignment of optical fibers 801 substantially as described above in the context of FIG. 5.

Optical interconnect component 701 includes a sloped contact alignment surface 750 that stands-off from the surrounding optical interconnect component mount surface. Alignment surface 750 is again to passively align optical interconnect component 701, converting downward assembly force into lateral motion along at least one of the y-dimension and x-dimensions as an adhesive between optical interconnect component 701 and PIC chip 201 collapses under compressive assembly force. In the illustrated example, optical interconnect component 701 includes a protrusion with two opposing sloped alignment surfaces 750 extending in a direction substantially parallel to the x-axis. Alternatively, sloped alignment surfaces 750 may comprise a detent into solid body 705. Advantageously, optical interconnect component 701 includes at least two such detents or protrusions. In the illustrated example, there are two protrusions with parallel alignment surfaces 750. Solid body 705 has a transverse width W, between the pair of protrusions, that spans planar waveguides 210.

In addition to alignment surfaces 222 with a land of PIC chip 201 where the fiber array is mounted, PIC chip 201 includes a sloped contact alignment surface 250 that stands-off from a surrounding region where optical interconnect component 701 lands. Sloped alignment surface 250 may be complementary to that of alignment surface 750. For example, where alignment surface 750 protrudes from solid body 705, alignment surface 250 recesses from the surrounding surface of PIC chip 201. In alternative embodiments where alignment surface 750 recesses from a surrounding face of solid body 705, alignment surface 250 protrudes from the surrounding surface of PIC chip 201. PIC chip 201 may include any number of alignment surfaces 250, but in exemplary embodiments there is a 1:1 correspondence between alignment surfaces 250 and alignment surfaces 750. In the illustrated example, there are a pair of opposing alignment surfaces 250 sloped along the y-dimension with each of a pair of detents on opposite sides of the transverse width of PIC chip 201 comprising the plurality of waveguides 210. Alignment surface(s) 250 may be etched into PIC chip 201, for example concurrently with formation of alignment surfaces 222.

During assembly, physical contact between alignment surfaces 750 and 250 passively aligns optical interconnect component 701 to be positioned along the y-axis at a location where each lens 780 is in alignment with each planar waveguide 210. Face 706 protrudes from the mounting surface of optical interconnect component to lap edge face 206. Optical interconnect component 701 may therefore be positioned along the x-axis as stopped by physical contact between edge face 206 an overlapping portion of solid body 705.

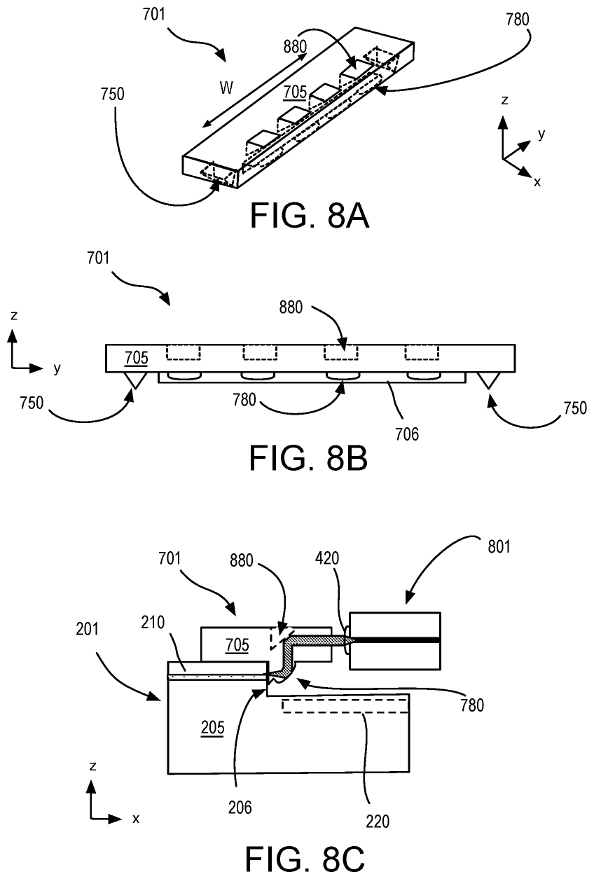

FIG. 8A is an isometric illustration of optical interconnect component 701 comprising an array of lenses 780 and mirror facets 880, in accordance with some alternative embodiments. FIG. 8B is a transverse cross-sectional view of the optical interconnect component 701 illustrated FIG. 8A. FIG. 8C is a longitudinal cross-sectional view of PIC chip 201 assembled with optical interconnect component 701 of FIG. 8A-8B, in accordance with some embodiments. Optical interconnect component 701 again comprises optical lenses 780 integral with solid body 705. Sloped alignment surfaces 750 are drawn in dashed line in FIG. 8A and solid line in FIG. 8B. In this example, alignment surfaces 750 are on a pair of protrusions at opposite sides of the linear array of lenses 780.

Lenses 780 are aligned along transverse width W with TIR mirror facets 880. As shown in FIGS. 8B and 8C, mirror facets 880 are detents within solid body 705 comprising a sloped planar facet sloped along the x-axis. A first region of optical interconnect component 701 is mounted to PIC 201 over planar waveguides 210 according to contact between alignment surfaces 750 and corresponding alignment surfaces (not visible in plane illustrated in FIG. 8C) of PIC chip 201. A second region of optical interconnect component 701 is aligned in the z-dimension with a portion of edge facet 206 to couple an individual waveguide 210 with an individual lens 780. In this example, lens 780 is a parabolic TIR lens that propagates light through solid body 705 to the angled TIR mirror 880, which further propagates light out of solid body 705 where it propagates through free-space to optical fiber 801. In this example, an end of optical fiber 801 includes focusing lens 420 that forms a converging beam into a fiber core.

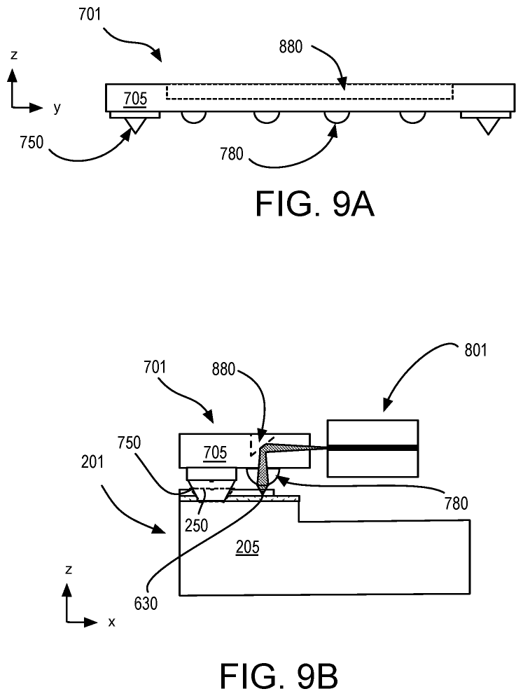

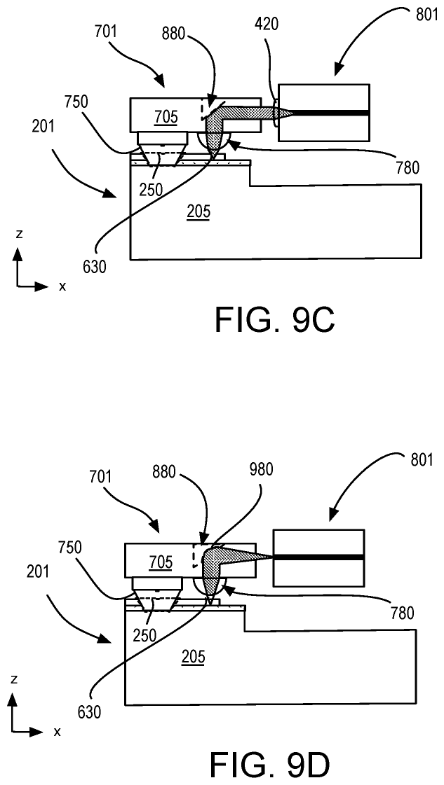

An optical interconnect component of the type described above may also be mounted to a PIC chip with planar waveguides that terminate at a vertical output coupler. FIG. 9A is a transverse cross-sectional view of an optical interconnect component 701, in accordance with some alternative vertical output coupler embodiments. FIG. 9B is a longitudinal cross-sectional view of an vertically coupled PIC chip package including optical interconnect component 701, in accordance with some further embodiments. As illustrated, optical interconnect component 701 again comprises an array of lenses 780 and a TIR mirror facet 880, each integral within solid body 705. As shown in FIG. 9B, lenses 780 are over vertical (e.g., grating) couplers 630. Lenses 780 are spherical, which may focus or collimate a diverging beam. Angled mirror facet 880 redirects the beam by 90-degrees into a core of optical fiber 701. In this example, lenses 780 have a focal distance sufficient to include free-space propagation to fiber 701, so no additional focusing lens is needed.

FIGS. 9C and 9D are longitudinal cross-sectional views of vertically-coupled PIC chip packages including an optical interconnect component, in accordance with some alternative embodiments. As shown in FIG. 9C, sloped alignment surfaces 750 contact alignment surfaces 250 and passively align lenses 780 with vertical couplers 630. In this example, spherical lenses 780 collimate the beam such that a focusing lens 420 further improves coupling with a core of optical fiber 801. FIG. 9D illustrates an example where TIR mirror 880 comprises a parabolic surface 980, which directs a convergent/focused beam to optical fiber 701.

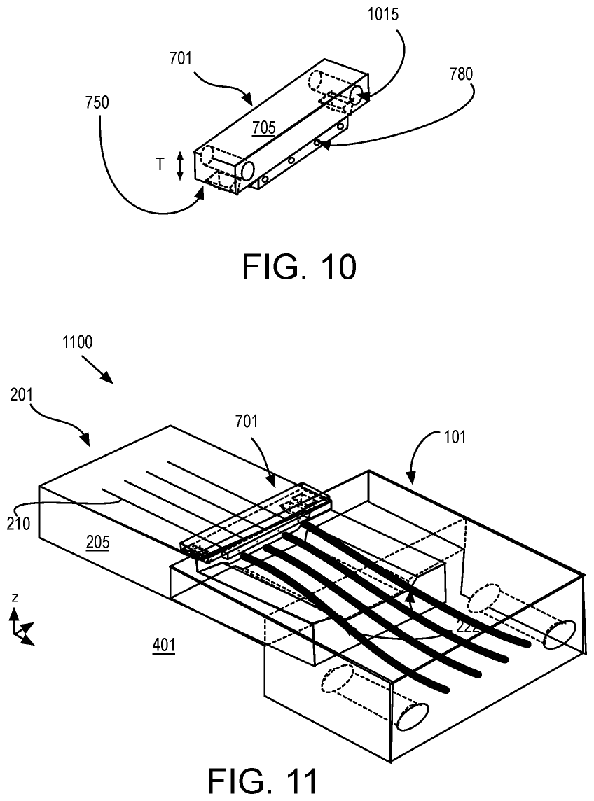

Any of the embodiments of an optical interconnect component as described above may further include one or more interference fittings within a face of the interconnect component, for example to receive a connector comprising one or more optical fibers. FIG. 10 illustrates guide holes 1015 that have been milled or molded into a face of optical interconnect component 701. For such embodiments, solid body 705 has a sufficient thickness T to accommodate guide holes 1015, which may be hundreds of microns in diameter.

As noted above, optical interconnect components suitable for improving coupling efficiency between either an edge coupled or vertically coupled planar waveguide with an optical fiber may also be assembled with an MT-pluggable optical interconnect component, for example as described elsewhere herein. FIG. 11 is an isometric illustration of a system 1100 including a photonic IC (PIC) chip package comprising two passively aligned optical interconnect components, in accordance with some embodiments. Optical interconnect component 101 is attached to a first region of PIC chip 201, and may have any of the attributes described above. Optical interconnect component 701 is attached to a second region of PIC chip 201, and may also have any of the attributes described above. Hence, while a PIC chip assembly may comprise either optical interconnect component 101 or optical interconnect component 701, a PIC chip assembly may also include both optical interconnect component 101 and optical interconnect component 701.

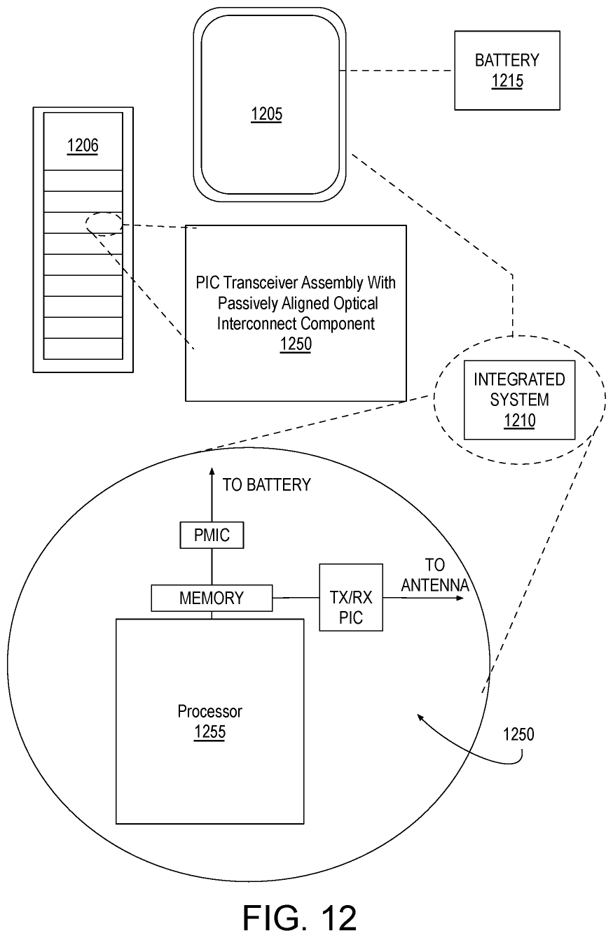

FIG. 12 illustrates a mobile computing platform and a data server machine employing a PIC chip assembly with an optical interconnect component, for example as described elsewhere herein. The server machine 1206 may be any commercial server, for example including any number of high-performance computing platforms disposed within a rack and networked together for electronic data processing, which in the exemplary embodiment includes a packaged monolithic SoC. The mobile computing platform 1205 may be any portable device configured for each of electronic data display, electronic data processing, wireless electronic data transmission, or the like. For example, the mobile computing platform 1205 may be any of a tablet, a smart phone, laptop computer, etc., and may include a display screen (e.g., a capacitive, inductive, resistive, or optical touchscreen), a chip-level or package-level integrated system 1210, and a battery 1215.

As a system component within the server machine 1206, package 1250 may include a memory block (e.g., RAM) and a processor block (e.g., a microprocessor, a multi-core microprocessor, baseband processor, or the like) further including a photonic IC comprising a planar optical waveguide coupled to an optical interconnect component, such as any of those described elsewhere herein. Package 1250 may include one or more of a power management integrated circuit (PMIC), RF (wireless) integrated circuit (RFIC) including a wideband RF (wireless) transmitter and/or receiver (TX/RX), and memory interconnected through an RDL routing structure, which may be further interconnected onto a host board within either server 1206 or mobile device 1205.

Functionally, a PMIC may perform battery power regulation, DC-to-DC conversion, etc., and may therefore an input coupled to battery 1215 and an output providing a current supply to other functional modules. RFIC may have an output coupled to an antenna (not shown) to implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond.

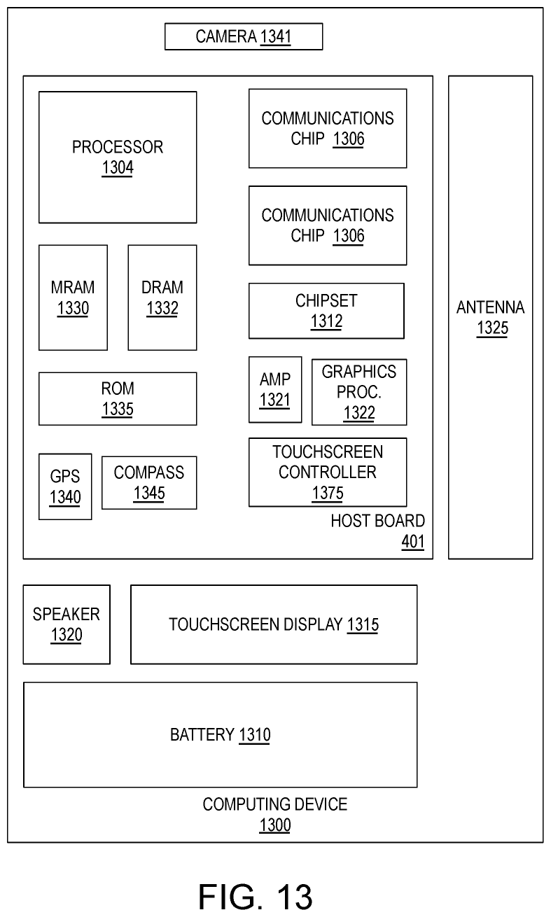

FIG. 13 is a functional block diagram of an electronic computing device, in accordance with some embodiments. Computing device 1300 may be found inside platform 1205 or server machine 1206, for example. Device 1300 further includes host board 1095 hosting a number of components, such as, but not limited to, a processor 1304 (e.g., an applications processor. In some examples, one or more of the components of device 1300 includes a PIC chip coupled to an optical interconnect component, for example as described elsewhere herein. In general, the term “processor” or “microprocessor” may refer to any device or portion of a device that processes electronic data from registers and/or memory to transform that electronic data into other electronic data that may be further stored in registers and/or memory.

In various examples, one or more communication chips 1306 may also be physically and/or electrically coupled to processor 1304. Depending on its applications, computing device 1300 may include other components that may or may not be physically and electrically coupled to motherboard 1302. These other components include, but are not limited to, volatile memory (e.g., DRAM 1332), non-volatile memory (e.g., ROM 1335 or MRAM 1130), a graphics processor 1322, an antenna 1325, touchscreen display 1315 battery 1310, power amplifier 1321, global positioning system (GPS) device 1340, compass 1345, speaker 1320, camera, 1341, and mass storage device (such as hard disk drive, solid-state drive (SSD), compact disk (CD), digital versatile disk (DVD), and so forth), or the like.

Communication chips 1306 may enable wireless communications for the transfer of data to and from the computing device 1300. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Communication chips 1306 may implement any of a number of wireless standards or protocols, including but not limited to those described elsewhere herein. As discussed, computing device 1300 may include a plurality of communication chips 1306. For example, a first communication chip may be dedicated to shorter-range wireless communications, such as Wi-Fi and Bluetooth, and a second communication chip may be dedicated to longer-range wireless communications such as GPS, EDGE, GPRS, CDMA, WiMAX, LTE, Ev-DO, and others.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In first examples, a photonic integrated circuit (PIC) interconnect component comprises an array of optical waveguides embedded within a solid body and extending a longitudinal length between a first face of the solid body and a second face of the solid body. The optical waveguides are laterally spaced apart across a transverse width of the first face. The component comprises an interference fitting on the second face, laterally adjacent to an end of the optical waveguide. The component comprises a protrusion or detent on a third face of the solid body, wherein the protrusion or detent comprises a contact alignment surface that stands off from a remainder of the third face and is sloped along a portion of the transverse width.

In second examples, for any of the first examples the interference fitting is to interface with a complementary fitting of a multi-fiber ferrule connector.

In third examples, for any of the first through second examples the solid body comprises predominantly a polymer or glass.

In fourth examples, for any of the first through fourth examples the contact alignment surface is to induce a lateral force in response to a downward force applied through contact of the contact alignment surface with a surface of a host component.

In fifth examples, for any of the fourth examples the protrusion or detent comprises a V-protrusion comprising two intersecting contact alignment surfaces spanning a maximum width of at least 50 μm.

In sixth examples, for any of the first through fifth examples the solid body further comprises an array of optical elements on the first face, each of the optical elements comprising at least one of an optical lens or total internal reflection (TIR) mirror.

In seventh examples, for any of the sixth examples each of the optical elements comprises the optical lens. The optical lens comprises a focusing lens, and an individual one of the optical waveguides is within a focal distance of the focusing lens.

In eighth examples, for any of the sixth through seventh examples each of the optical elements comprises the TIR mirror and the TIR mirror is at least one of a planar, a parabolic, or a conic TIR mirror.

In ninth examples, for any of the first through eighth examples the first face is substantially parallel to an output coupler (OC) of a PIC chip when the contact alignment surface is to interface with a complementary detent or protrusion on the PIC chip.

In tenth example, for any of the ninth examples the first face is to be substantially parallel to an edge coupler (EC) of the PIC chip when the contact alignment surface is in contact with the complementary detent or protrusion.

In eleventh examples for any of the tenth examples the first face is to be substantially parallel to a vertical output coupler of the PIC chip when the contact alignment surface is in contact with the complementary detent or protrusion.

In twelfth examples, a photonic integrated circuit (PIC) assembly comprises a PIC chip comprising a plurality of planar optical waveguides spaced apart in a first dimension and each terminating at an output coupler (OC), and a surface detent or protrusion laterally adjacent to the OC. The assembly comprises the PIC interconnect component of the first through eleventh examples mounted to the PIC chip. The first face of the solid body interfaces the OC and the contact alignment surface contacts the surface detent or protrusion.

In thirteenth examples, for any of the twelfth examples the PIC chip is attached to a host component, and the second face overhangs the host component, beyond an edge of the PIC chip.

In fourteenth examples, for any of the twelfth through thirteenth examples the assembly further comprises a ferrule connector comprising an optical fiber. Friction with the interference fitting on the second face maintains a connection between the ferrule connector and the PIC interconnect component.

In fifteenth examples, an assembly method comprises receiving a photonic integrated circuit (PIC) chip, wherein the PIC chip comprises a plurality of planar optical waveguides spaced apart in a first dimension and each terminating at an output coupler (OC), and a first detent or protrusion laterally adjacent to the output couplers. The method comprises surface mounting an interconnect component to the PIC chip with a pick-and-place machine. The interconnect component comprises an array of optical waveguides embedded within a solid body, the optical waveguides extending a longitudinal length between a first face of the solid body and a second face of the solid body, and laterally spaced apart across a transverse width of the first face. The interconnect component comprises an interference fitting on the second face, laterally adjacent to an end of the optical waveguide and a second protrusion or second detent on a third face of the solid body. During the surface mounting, the first face is laterally aligned within the first dimension to the OC through mechanical interference between the first detent and the second protrusion, or between the first protrusion and the second detent.

In sixteenth examples, for any of the fifteenth examples the pick-and-place machine has a position alignment precision capability of no better than +/−3 μm, and at least one of the first or second detents or protrusions comprise an alignment surface that is sloped within the first dimension, and has a maximum lateral width of at least 50 μm.

In seventeenth examples, a photonic integrated circuit (PIC) assembly comprises a PIC chip comprising a plurality of planar optical waveguides spaced apart in a first dimension and each terminating at an output coupler (OC), and the chip comprises a first surface detent or protrusion laterally adjacent to the OC. The assembly comprises an interconnect component mounted to the PIC chip. The interconnect component is a solid body comprising a first face substantially parallel to the output couplers. The component comprises a plurality of optical elements linearly arrayed over a transverse width of the solid body. Each of the optical elements comprise at least a lens or a total internal reflection (TIR) mirror dimensioned and spaced to collect light from one of the output couplers. The component comprises a second protrusion or detent on a face of the solid body. At least one of the first or second detents or protrusions comprise a contact alignment surface that is sloped within the first dimension.

In eighteenth examples, for any of the seventeenth examples the optical elements are to output light through a second face of the solid body, and the solid body further comprises an interference fitting on the second face.

In nineteenth examples, for any of the eighteenth examples the assembly further comprises a ferrule connector comprising an optical fiber, wherein friction with the interference fitting on the second face maintains a connection between the ferrule connector and the PIC interconnect component.

In twentieth examples, for any of the seventeenth examples the solid body comprises predominantly a polymer or glass.

In twenty-first examples, for any of the seventeenth through twentieth examples the contact alignment surface is to induce a lateral force in response to a downward force applied through the contact of the contact alignment surface with a surface of the PIC chip.

In twenty-second examples, for any of the seventeenth through twenty-first examples each of the optical elements comprises the optical lens, and wherein the optical lens comprises a collimation lens.

In twenty-third examples, for any of the seventeenth through twenty-second examples each of the optical elements comprises the TIR mirror and wherein the TIR mirror is at least one of a planar, a parabolic, or a conic TIR mirror.

It will be recognized that principles of the disclosure are not limited to the embodiments so described, but can be practiced with modification and alteration without departing from the scope of the appended claims. The above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A photonic integrated circuit (PIC) interconnect component, comprising:
an array of optical waveguides embedded within a solid body and extending a longitudinal length between a first face of the solid body and a second face of the solid body, wherein the optical waveguides are laterally spaced apart across a transverse width of the first face;
an interference fitting on the second face, laterally adjacent to an end of the optical waveguide; and
a protrusion or detent on a third face of the solid body, wherein the protrusion or detent comprises a contact alignment surface that stands off from a remainder of the third face and is sloped along a portion of the transverse width.

2. The PIC interconnect component of claim 1, wherein the interference fitting is to interface with a complementary fitting of a multi-fiber ferrule connector.

3. The PIC interconnect component of claim 2, wherein the solid body comprises predominantly a polymer or glass.

4. The PIC interconnect component of claim 1, wherein the contact alignment surface is to induce a lateral force in response to a downward force applied through contact of the contact alignment surface with a surface of a host component.

5. The PIC interconnect component of claim 4, wherein the protrusion or detent comprises a V-protrusion comprising two intersecting contact alignment surfaces spanning a maximum width of at least 50 μm.

6. The PIC interconnect component of claim 1, wherein the solid body further comprises an array of optical elements on the first face, each of the optical elements comprising at least one of an optical lens or total internal reflection (TIR) mirror.

7. The PIC interconnect component of claim 6, wherein each of the optical elements comprises the optical lens, and wherein the optical lens comprises a focusing lens, and wherein an individual one of the optical waveguides is within a focal distance of the focusing lens.

8. The PIC interconnect component of claim 6, wherein each of the optical elements comprises the TIR mirror and wherein the TIR mirror is at least one of a planar, a parabolic, or a conic TIR mirror.

9. The PIC interconnect component of claim 1, wherein the first face is substantially parallel to an output coupler (OC) of a PIC chip when the contact alignment surface is to interface with a complementary detent or protrusion on the PIC chip.

10. The PIC interconnect component of claim 9, wherein the first face is to be substantially parallel to an edge coupler (EC) of the PIC chip when the contact alignment surface is in contact with the complementary detent or protrusion.

11. The PIC interconnect component of claim 9, wherein:
first face is to be substantially parallel to a vertical output coupler of the PIC chip when the contact alignment surface is in contact with the complementary detent or protrusion.

12. A photonic integrated circuit (PIC) assembly, comprising:
a PIC chip comprising;
a plurality of planar optical waveguides spaced apart in a first dimension and each terminating at an output coupler (OC); and
a surface detent or protrusion laterally adjacent to the OC; and
the PIC interconnect component of claim 1 mounted to the PIC chip, wherein the first face of the solid body interfaces the OC and the contact alignment surface contacts the surface detent or protrusion.

13. The PIC assembly of claim 12, wherein:
the PIC chip is attached to a host component; and
the second face overhangs the host component, beyond an edge of the PIC chip.

14. The PIC assembly of claim 12, further comprising a ferrule connector comprising an optical fiber, wherein friction with the interference fitting on the second face maintains a connection between the ferrule connector and the PIC interconnect component.

15. A method, comprising:
receiving a photonic integrated circuit (PIC) chip, wherein the PIC chip comprises:
a plurality of planar optical waveguides spaced apart in a first dimension and each terminating at an output coupler (OC); and
a first detent or protrusion laterally adjacent to the output couplers;
surface mounting an interconnect component to the PIC chip with a pick-and-place machine, wherein the interconnect component comprises:
an array of optical waveguides embedded within a solid body, the optical waveguides extending a longitudinal length between a first face of the solid body and a second face of the solid body, and laterally spaced apart across a transverse width of the first face;
an interference fitting on the second face, laterally adjacent to an end of the optical waveguide; and
a second protrusion or second detent on a third face of the solid body, and
wherein, during the surface mounting, the first face is laterally aligned within the first dimension to the OC through mechanical interference between the first detent and the second protrusion, or between the first protrusion and the second detent.

16. The method of claim 15, wherein:
the pick-and-place machine has a position alignment precision capability of no better than +/−3 μm; and
at least one of the first or second detents or protrusions comprise an alignment surface that is sloped within the first dimension, and has a maximum lateral width of at least 50 μm.

17. A photonic integrated circuit (PIC) assembly, comprising:
a PIC chip comprising;
a plurality of planar optical waveguides spaced apart in a first dimension and each terminating at an output coupler (OC); and
a first surface detent or protrusion laterally adjacent to the OC; and
an interconnect component mounted to the PIC chip, wherein the interconnect component is a solid body comprising:
a first face substantially parallel to the output couplers;
a plurality of optical elements linearly arrayed over a transverse width of the solid body, wherein each of the optical elements comprise at least a lens or a total internal reflection (TIR) mirror dimensioned and spaced to collect light from one of the output couplers; and
a second protrusion or detent on a face of the solid body, wherein at least one of the first or second detents or protrusions comprise a contact alignment surface that is sloped within the first dimension.

18. The PIC assembly of claim 17, wherein the optical elements are to output light through a second face of the solid body, and the solid body further comprises an interference fitting on the second face.

19. The PIC assembly of claim 18, further comprising a ferrule connector comprising an optical fiber, wherein friction with the interference fitting on the second face maintains a connection between the ferrule connector and the PIC interconnect component.

20. The PIC assembly of claim 17, wherein the solid body comprises predominantly a polymer or glass.

21. The PIC assembly of claim 17, wherein the contact alignment surface is to induce a lateral force in response to a downward force applied through the contact of the contact alignment surface with a surface of the PIC chip.

22. The PIC assembly of claim 17, wherein each of the optical elements comprises the optical lens, and wherein the optical lens comprises a collimation lens.

23. The PIC interconnect assembly of claim 17, wherein each of the optical elements comprises the TIR mirror and wherein the TIR mirror is at least one of a planar, a parabolic, or a conic TIR mirror.
